(19) United States
(12) Patent Application Publication
(10) Pub. No.: US 2020/0051105 A1
(43) Pub. Date: Feb. 13, 2020

(54) REWARD PREDICTION CALCULATING SYSTEM, REWARD PREDICTION CALCULATING SERVER, REWARD PREDICTION CALCULATING COMPUTER PROGRAM PRODUCT, AND REWARD PREDICTION CALCULATING METHOD

(71) Applicant: MEDIUM CO., LTD., TOKYO (JP)

(72) Inventors: YASUO MAZAKI, NARA (JP); SUSUMU URASHIMA, NARA (JP); NAOAKI OKUBO, TOKYO (JP); EIICHIRO FUJIWARA, TOKYO (JP)

(21) Appl. No.: 16/342,754

(22) PCT Filed: Oct. 19, 2016
(86) PCT No.: PCT/JP2016/081024

§ 371 Date: Apr. 17, 2019

(51) Int. Cl. G06Q 30/02

(52) U.S. Cl. CPC G06Q 30/0214; G06Q 30/0213

(57) ABSTRACT

The invention disclosed relates to a reward prediction calculating system, a reward prediction calculating server, a reward prediction calculating computer program product, and a reward prediction calculating method that estimate a reasonable reward to a participant member in a referral sale distribution membership group. The reward determination rule comprises allocation information, with the participant members being mapped after the participant members are respectively virtually allocated to one node in a binary tree data structure to form filled levels; and
a calculation of the reward amount for all participant members, which is performed on a basis of the allocation information of a total purchasing merchandise item amount that is the total amount of merchandise items that are purchased by other participant members in a lower level branching from the subject participant member, a predetermined maximum limitation amount, and a predetermined reward base value such that a temporary reward amount is obtained by performing an estimation which discretizes the reward base value to all allocation levels in connection to the total purchasing merchandise item amount, and the reward amount is calculated on a basis that the temporary reward amount is not larger than the maximum reward amount.

### FIELD OF THE INVENTION

The present invention relates to a reward prediction calculating system, a reward prediction calculating server, a reward prediction calculating computer program product, and a reward prediction calculating method in relation to a prediction for a reasonable reward in a referral sale distribution membership group.

### BACKGROUND OF THE INVENTION

A referral sale distribution membership group can be varied as a lot of types. The basic type thereof is that a person who purchases the merchandise sold by an incorporated company through an introduction of a participant member of the incorporated company can join the referral sale distribution membership group as a new participant member, and thereafter the incorporated company will pay commission (bonus) to the participant member who introduces the new participant member.

A participant member in the referral sale distribution membership group can earn bonus not only by selling merchandise but also by introducing a new participant member to the incorporated company. In addition, the incorporated company can be taken as with an infrastructure that the merchandise is in no-shop sale and can be considered as a membership organization which is formed through an introduction. A referral sale distribution membership group has been considered with benefits for both the participant member and the incorporated company, and therefore it had been such a period of time that the development of the referral sale distribution membership group was expanding to a large scale.

However, on the contrary to the above advantage, a reward plan drawn up by an incorporated company with an excessive reward will lead a bankruptcy of the incorporated company, and alternatively a reward plan being continuously modified in order to prevent from the bankruptcy will thus make the participant members feel uncomfortable by which it causes another reason for a dissolution of the membership group. As a result, it becomes to receive the limitation of law, and the number of incorporated companies became less.

In spite that one of the reasons causing this situation is a reward plan with too excessive reward, there is another reason that an incorporated company is difficult to properly draw up a reward plan. If a lot of new participant members can promptly join the referral sale distribution membership group, the incorporated company thereof can go continuing its business even though a reward is drawn as a large one. However, in a situation that the reward is large, there will have more new participant members joining the group to thus cause a higher bankruptcy risk of the incorporated company since there are more rewards needed to be paid. On the contrary, in a situation that the reward is little, there will have fewer new participant members joining the group since the attraction to participant members becomes less.

An appropriate reward plan for the incorporated company is determined depending on factors including a price and attraction of merchandise to be handled, and also including a number of participant members and economic trend, etc. It is generally difficult to predict how much reward amount should be determined to draw up an appropriate plan. The sociality has a strong request that an incorporated company can draw up an appropriate reward plan. However, in prior art, it stays on the prediction according to the experience of the planner's experience, but there has not yet a prediction going together with an effective estimation in way of quantification.

In this situation, a lot of inventors have tried in way of quantification to perform an estimation for a reward plan in a referral sale distribution membership group forming with a hierarchical sales organization where one of the participant member introduces a new participant member and thereafter the new participant member(s) further introduces other new participant members to form two branches. However, in spite that the methods proposed by the inventors in the prior art have introduced a bonus percentage (elimination percentage D(n)) and have limited the highest reward amount to be received, these methods are difficult to provide a flexible reward plan (Patent Document 1).

In addition, there is another method proposed by a inventor that it limits the maximum amount of the obtained reward for different bonus percentage (elimination percentage D(n)) such that it is still difficult to provide a flexible reward plan (Patent Document 2).

Therefore, it is desirable to have an effective and versatile reward predication calculating device and method thereof which properly flexibly determines a reasonable reward plan for participant member by using a calculated bonus percentage which will absolutely be converged even though the level n becomes larger and the degree becomes deeper.

### CITATION LIST

### Patent Documents

Patent Document 1: JP2008-90804

Patent Document 2: JP2013-47959

### SUMMARY OF THE INVENTION

### Technical Problem

Accordingly, one of the objectives of the present invention is to provide a reward prediction calculating system, a reward prediction calculating server, a reward prediction calculating computer program product, and a reward prediction calculating method that can estimate a reasonable reward for participant members in a referral sale distribution membership group.

### Solution to Problem

In order to achieve the effect mentioned above, the present invention provides a reward prediction calculating system that predicts, according to a reward amount of a participant member, bonus percentage of the participant member who participates in a referral sale distribution membership group, the reward prediction calculating system comprising:

an input device that inputs variable conditions, a calculation command, and then a determination command, the variable conditions being used to calculate the reward amount;

a storage device that records the inputted variable conditions and a reward determination rule, the reward determination rule being with converged bonus percentages;

a control device that repeatedly, from the input of the calculation command until the input of the determination command, calculates the reward amount to perform the prediction of the bonus percentages according to the variable conditions and the reward determination rule;

a display device that displays the obtained prediction of the bonus percentages; and

an output device that outputs, when the determination command is inputted, the bonus percentages and the variable conditions as determination data, the bonus percentages being related to the determination command, and the variable conditions being synchronously stored while being displayed,

wherein the reward determination rule comprises:

[1] allocation information, with the participant members being mapped after the participant members are respectively virtually allocated to one node in a binary tree data structure to form filled levels; and

[2] a calculation of the reward amount for all participant members, which is performed on a basis of the allocation information of a total purchasing merchandise item amount that is the total amount of merchandise items that are purchased by other participant members in a lower level branching from the subject participant member, a predetermined maximum limitation amount, and a predetermined reward base value such that a temporary reward amount is obtained by performing an estimation which discretizes the reward base value to all allocation levels in connection to the total purchasing merchandise item amount, and the reward amount is calculated on a basis that the temporary reward amount is not larger than the maximum reward amount.

Due to the above, the bonus percentages are converged even though participant member levels are infinitely deepened, the reward amount estimation that is obtained based on the corresponding converged bonus percentages under various variable conditions is able to be performed.

Moreover, a parameter of reward base value is introduced, and then the reward base value is used to discrete the total purchasing merchandise item amount such that a temporary reward amount added with an evaluation is calculated. By means of this, the total purchasing merchandise item amount is rounded off to a hierarchical value in every arbitrary stairs form, i.e., in every step form, such that the reward prediction and bonus percentages can be calculated. And not only the maximum amount can be limited but a payment of the incorporated company for the determination reward amount can also be adjusted with the variable reward base value. In addition, since the total purchasing amount of merchandise expected to be linked up to the amount of reward is used as the reward base value to adjust reward amount, it is more acceptable by participant members.

In addition, the participant members in the upper levels (sballow levels) have a limited maximum reward amount, and the participant members in the lower levels (deep levels) have the reward amount corresponding to the total purchasing merchandise item amount. For this reason, in spite that it limits the maximum reward amount for participant members in the upper levels that have higher rewards, it does not reduce the reward amount for participant members belonging to lower level that does not reach the maximum reward amount, i.e., for participant members introducing fewer new participant members. Therefore participant members can have incentive motivation for participant member introduction. And since such payment terms of the reward can be advised in advance, it is easier to be accepted. For the incorporated company, since the bonus percentage can be easier estimated when there is a simultaneous change both in the maximum amount and the reward base value, it can flexibly make various reward plans.

The bonus percentages refer to a ratio of the bonus amount to the reward amount, where the bonus amount is from the sale in relation to the handled merchandizes of the referral sale distribution membership group. This bonus amount is not limited to the sale of the merchandizes itself but includes membership fee as a part of the group's income. In addition, it is not limited to the total sale amount, but may also be the amount that is deducted by the necessary expense.

Preferably, in relation to the reward amount of the participant member who belongs to the i-th level in a binary tree of depth n, when the maximum reward amount is M, the base reward amount is h, the reward base is g, the purchasing merchandise item amount for each participant member is 1, the total purchasing merchandise item amount is S(i), and the temporary reward amount is P(i), INT{ } is an operator to obtain an integer value from the value in { }, and * is an accumulation operator, the temporary reward amount is determined as

P(i)=h*INT{S(i)/g},

the determined reward amount P(i) satisfies a relation of:

M≤P(i) and k+i=n+1,

wherein it is divided to two different conditions for calculating the reward amount according to a level which is with a number of m counting from the n-th level by which k becomes the smallest value,

### [Condition 1]:

for the participant member in level i where i≤n+1−m, the reward amount is calculated as the maximum reward amount M,

### [Condition 2]:

for the participant member in a level i where i>n+1−m, the temporary reward amount is calculated as the temporary reward amount of P(i)=h*INT {(2n−i+1−2)/g}.

Due to the mechanism as above, since the bonus percentages will converge even though a participant member level is infinitely deepened, it can estimate the reward plan in way of quantification.

Moreover, since a discretization is applied to turn the estimation value to the reward base amount which is taken as a temporary reward amount, the reward amount can be taken as three main parameters including the maximum reward amount, the reward base and the base reward amount. Therefore, it can flexible determine a reward plan.

In order to achieve the effect mentioned above, the present invention provides a reward prediction calculating server that predicts, according to a reward amount of a participant member, bonus percentages of the participant member who participates to a referral sale distribution membership group, the reward prediction calculating server comprising:

a communication component that is configured to be communicable with a terminal unit via a network to receive data related to a calculation of the reward amount from the terminal unit, and to send bonus percentages to the terminal unit, the received data including the variable conditions, a calculation command, and a determination command, and the bonus percentages obtained by a calculation and including an estimated bonus percentage and the bonus percentages which are taken as determination data while the determination command is received;

a storage component that records the received variable conditions and a reward determination rule, the reward determination rule being with converged bonus percentages;

a control component that repeatedly, from the receipt of the calculation command until the receipt of the determination command, calculates the reward amount to perform the prediction of the bonus percentages according to the variable conditions and the reward determination rule;

a data providing component that provides, after the receipt of the determination command, the predicted bonus percentage and an amount estimation in connection to the bonus percentages to the terminal unit, wherein the reward determination rule comprises:

[1] allocation information, with the participant members being mapped after the participant members are respectively virtually allocated to one node in a binary tree data structure to form filled levels; and

[2] a calculation of the reward amount for all participant members, which is performed on a basis of the allocation information of a total purchasing merchandise item amount that is the total amount of merchandise items that are purchased by other participant members in a lower level branching from the subject participant member, a predetermined maximum limitation amount, and a predetermined reward base value such that a temporary reward amount is obtained by performing an estimation which discretizes the reward base value to all allocation levels in connection to the total purchasing merchandise item amount, and the reward amount is calculated on a basis that the temporary reward amount is not larger than the maximum reward amount.

Due to the mechanism as above, since the bonus percentages must be converged even though a participant member level is infinitely deepened, it can provide a terminal device, through a network, with an amount estimation for variable conditions according to the converged bonus percentage. Moreover, it introduces a parameter called as a reward base value, and performs a discretization by using the reward base value in connection to a total purchasing merchandise item amount so as to calculate a temporary reward amount which adds with estimation. By means of the above, since the total purchasing merchandise item amount can be cut down to a rounded value in arbitrary stairs form, i.e., steps form, the bonus percentage is calculated respectively and the reward base value has been changed such that the bonus amount can be eventually simply trial calculated.

In addition, a participant member belonging to an upper level, i.e., a shallow level, has been limited about a maximum reward limited amount, and a participant member belonging to a lower level, i.e., a deep levels, is with a reward amount corresponding to the total purchasing merchandise item amount. For this reason, in spite that a participant member belonging to an upper level who receives a comparative higher amount of reward has been limited about the maximum limited amount, it does not have an amount reduction for a participant member belonging to a lower level who does not reach the maximum limited amount. Therefore, it is easier for a participant member to have a motivation of participant member introduction, and since it becomes easier to know the reward payment condition, it is easier to accept it. Moreover, since an incorporated company can easily perform a bonus percentage estimation for a situation that the maximum limited amount and the reward base value are synchronously changed, it can flexibly evaluate various reward plans.

In order to achieve the effect mentioned above, the present invention provides a reward prediction calculating computer program product that predicts bonus percentages of the participant member who participates to a referral sale distribution membership group, the reward prediction calculating computer program product is provided to enable a computer to function as:

an input element that inputs the variable conditions, a calculation command, and then a determination command, the variable conditions being used to calculate the reward amount;

a storage element that records the inputted variable conditions and a reward determination rule, the reward determination rule being with converged bonus percentages;

a control element that repeatedly, from the input of the calculation command until the input of the determination command, calculates the reward amount to perform the prediction of the bonus percentages according to the variable conditions and the reward determination rule;

a display element that displays the obtained prediction of the bonus percentages; and

an output element that outputs, when the determination command is inputted, the bonus percentages and the variable conditions as determination data, the bonus percentages the variable conditions being synchronously stored while being displayed,

wherein the reward determination rule comprises:

[1] allocation information, with the participant members being mapped after the participant members are respectively virtually allocated to one node in a binary tree data structure to form filled levels; and

[2] a calculation of the reward amount for all participant members, which is performed on a basis of the allocation information of a total purchasing merchandise item amount that is the total amount of merchandise items that are purchased by other participant members in a lower level branching from the subject participant member, a predetermined maximum limitation amount, and a predetermined reward base value such that a temporary reward amount is obtained by performing an estimation which discretizes the reward base value to all allocation levels in connection to the total purchasing merchandise item amount, and the reward amount is calculated on a basis that the temporary reward amount is not larger than the maximum reward amount.

Due to the mechanism as above, since the bonus percentages must be converged even though a participant member level is infinitely deepened, it can be provided a reward prediction calculating computer program product, through a computer, with an amount estimation for variable conditions according to the converged bonus percentage.

Moreover, it introduces a parameter called as a reward base value, and performs a discretization by using the reward base value in connection to a total purchasing merchandise item amount so as to calculate a temporary reward amount which adds with an estimation. By means of the above, since the total purchasing merchandise item amount can be cut down to a rounded value in arbitrary stairs form, i.e., steps form, the bonus percentage is calculated respectively and the reward base value has been changed such that the bonus amount can be eventually simply trial calculated.

In addition, a participant member belonging to an upper level, i.e., a shallow level, has been limited about a maximum reward limited amount, and a participant member belonging to a lower level, i.e., a deep levels, is with a reward amount corresponding to the total purchasing merchandise item amount. For this reason, in spite that a participant member belonging to an upper level who receives a comparative higher amount of reward has been limited about the maximum limited amount, it does not have an amount reduction for a participant member belonging to a lower level who does not reach the maximum limited amount. Therefore, it is easier for a participant member to have a motivation of participant member introduction, and since it becomes easier to know the reward payment condition, it is easier to accept it. Moreover, since an incorporated company can easily perform a bonus percentage estimation for a situation that the maximum limited amount and the reward base value are synchronously changed, it can flexibly evaluate various reward plans.

In addition, a reward prediction calculating method that predicts bonus percentages of the participant member who participates to a referral sale distribution membership group, the reward prediction calculating method comprising:

an input step that inputs the variable conditions for a calculation of the reward amount;

a storage step that records the inputted variable conditions;

a control step that repeatedly, from the input of the calculation command until the input of the determination command, calculates the reward amount to perform the prediction of the bonus percentages according to the variable conditions and the reward determination rule;

a display step that displays the obtained prediction of the bonus percentages; and

an output step that outputs, after the determination command is inputted, the bonus percentages and the variable conditions as determination data, the bonus percentages and the variable conditions being synchronously stored while being displayed,

wherein the reward determination rule comprises:

[1] allocation information, with the participant members being mapped after the participant members are respectively virtually allocated to one node in a binary tree data structure to form filled levels; and

[2] a calculation of the reward amount for all participant members, which is performed on a basis of the allocation information of a total purchasing merchandise item amount that is the total amount of merchandise items that are purchased by other participant members in a lower level branching from the subject participant member, a predetermined maximum limitation amount, and a predetermined reward base value such that a temporary reward amount is obtained by performing an estimation which discretizes the reward base value to all allocation levels in connection to the total purchasing merchandise item amount, and the reward amount is calculated on a basis that the temporary reward amount is not larger than the maximum reward amount

Due to the mechanism as above, since the bonus percentages must be converged even though a participant member level is infinitely deepened, it can be provided a reward prediction calculating method, through a computer, with an amount estimation for variable conditions according to the converged bonus percentage.

Moreover, it introduces a parameter called as a reward base value, and performs a discretization by using the reward base value in connection to a total purchasing merchandise item amount so as to calculate a temporary reward amount which adds with an estimation. By means of the above, since the total purchasing merchandise item amount can be cut down to a rounded value in arbitrary stairs form, i.e., steps form, the bonus percentage is calculated respectively and the reward base value has been changed such that the bonus amount can be eventually simply trial calculated.

In addition, a participant member belonging to an upper level, i.e., a shallow level, has been limited about a maximum reward limited amount, and a participant member belonging to a lower level, i.e., a deep levels, is with a reward amount corresponding to the total purchasing merchandise item amount. For this reason, in spite that a participant member belonging to an upper level who receives a comparative higher amount of reward has been limited about the maximum limited amount, it does not have an amount reduction for a participant member belonging to a lower level who does not reach the maximum limited amount. Therefore, it is easier for a participant member to have a motivation of participant member introduction, and since it becomes easier to know the reward payment condition, it is easier to accept it. Moreover, since an incorporated company can easily perform a bonus percentage estimation for a situation that the maximum limited amount and the reward base value are synchronously changed, it can flexibly evaluate various reward plans.

Furthermore, the term “output” mentioned above does not only represent “display” or “print”, but also represents a situation that it is taken as data to transmit to another program or device.

The term “input” represents an operation that passes through an interface to provide at least variable conditions to a CPU. The term “input device” or “input means” includes not only an interface to a human being, such as a keyboard, a mouse, or a voice input device, e.g, the keyboard 10 in the embodiment type of the present invention, but also an interface to other programs or computers such as an interface circuit and an interface program.

The term “program” represents not only one that is directly executable by a computer but also one that is executable by being installed to a hard disk or the like, and one that is with a compressed or encrypted format.

### Advantageous Effect of the Invention

By means of the present invention, since the bonus percentages must be converged even though a participant member level is infinitely deepened, an amount estimation for variable conditions can be provided according to the converged bonus percentage. In addition, since the maximum limited amount is determined by which level (depth) that each participant member is located in the group, it can flexibly evaluate various reward plans.

### BRIEF DESCRIPTION OF THE DRAWINGS

FIG. 1 is a schematic drawing illustrating the entire structure of the reward prediction calculating system according to the first embodiment type of the present invention;

FIG. 2 is a schematic drawing illustrating an example of a hardware structure using a CPU in the system of FIG. 1;

FIG. 3 is a flowchart illustrating a reward prediction calculating computer program product;

FIG. 4 is a schematic drawing illustrating the entire structure of the reward prediction calculating server with network according to the second embodiment type of the present invention;

FIG. 5 is a schematic drawing illustrating the processing procedure for the terminal unit and the server of FIG. 4;

FIG. 6 is a schematic drawing illustrating the entire structure of the server of FIG. 4;

FIG. 7 is a drawing illustrating the binary tree data structure of the referral sale distribution membership group of the present invention;

FIG. 8 is a drawing illustrating a calculation of bonus percentage based on the structure of FIG. 7.

### DESCRIPTION OF THE PREFERRED EMBODIMENTS

The following explains embodiment types of the present invention by referring to the drawings.

(A Referral Sale Distribution Membership Group Deployment, a Binary Tree Data Structure)

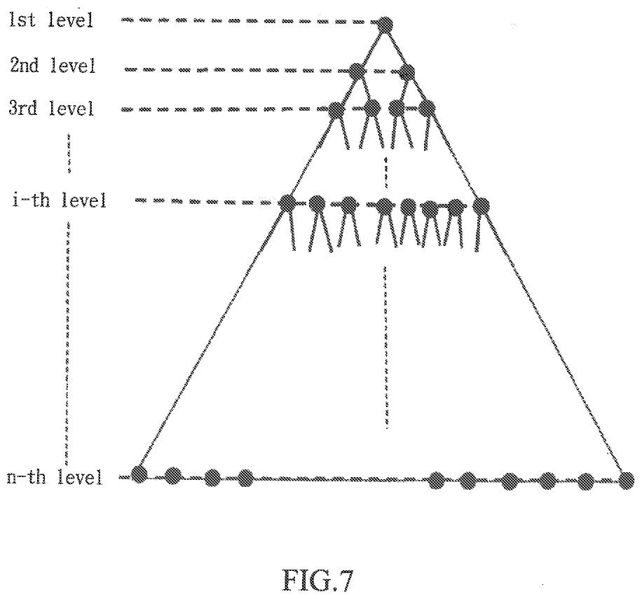

Before the explanation of examples, FIG. 7 is used to explain a binary tree data structure to which the referral sale distribution membership group is mapped, where the operation of the referral sale distribution membership group is performed by the reward prediction calculating system of the present invention. The referral sale distribution membership group is mapped to the binary tree data structure in order to predict the reward amount. Each participant member is respectively virtually located in each node of a binary tree which is a tree that two nodes are branching from one node of a binary tree to form a level. The black dot shown in FIG. 7 represents a participant member who is located at each node of the binary tree data structure. FIG. 7 shows a deployed referral sale distribution membership group which is filled with participant members from the 1st level (i.e., the root node) through the i-th level to the n-th level. Furthermore, some positions with black dots are omitted.

(A Deployment of the Referral Sale Distribution Membership Group)

A referral sale distribution membership group is deployed as described below. The incorporated companies are responsible for an operation of sale that sales merchandise handled by the incorporated company to new participant member (candidate) introduced by an existing participant member. When the sale is operated, the participant member (candidate) becomes a new participant members and the incorporated company will pay rewards to the existing participant member who introduces the new participant member in accordance with a reward determination rule. From the viewpoint of the participant members, in order to become a new participant member, it only needs to buy the handled merchandise of the incorporated companies via an introduction from the existing participant members.

As described above, a new participant member is virtually located at one node of the binary tree data structure. Once the new participant member introduces another new participant member (candidate) to the incorporated company, said another new participant member (candidate) is located at a lower level node branching from the node of said new participant member. Since an increase of participant members indicates the merchandise has been further sold, the participant members who introduced new participant members can get rewards.

As a result, since participant members can get rewards from the incorporated company through the introduction, it brings up the motivation of participant member introduction to increase participant member number. New participant members can also get the rewards in the same manner so that the referral sale distribution membership group will be further expanded.

The deployment of the referral sale distribution membership group is described in further detail as below. An original participant member, also called as “a top”, is virtually located in the “1st level”, called as “a root node”, of the binary tree structure. Next, the new participant member introduced by the original participant member is located in a lower level of the binary tree data structure, i.e., the new participant member is sequentially located at the “2nd level” nodes and their below. For example, since the 2^{nd} level nodes are two nodes connecting to a branch which branches from the first level to become two nodes, therefore if there is only one new participant member introduced, the one will be located at one node, and if there are two new participant members introduced, they will be located at the respective nodes. In the same manner, the binary tree data structure is extended to the lower levels by having each node branching into two nodes.

The number of new participant members introduced by existing participant members is not limited to only two. A participant member can introduce even three or more new participant members and the referral sale distribution membership group can still maintain the “binary tree data structure” to expand, i.e., it expands by forming a lower level that is branched to two nodes from one node.

(Prerequisite 1)

In the reward prediction of the present invention, there is a premise that the referral sale distribution membership group is mapped to a binary tree data structure filled with participant members until the n-th level (Prerequisite 1). Hereinafter, for convenience we call the branches, which branches from each one node to become two nodes, on the lift side or on the down side as a left one, and the branches on the right side or on the upper side as a right one in a view that sees the branch facing the paper.

The above-described “binary tree data structure” is particularly suitable for binary counting since it is branched into two node. When the left branch is assigned as “0” and the right branch is assigned as “1”, a node allocated with each participant member is uniquely determined with its position according to this binary representation. For example, the binary number of 101 corresponds to a node in the 2nd position counting from the left of the 3rd level, that is, top (the 1st level)→left (the 2nd level)→right (the 3rd level). Therefore, the positions allocated with the participant members are processed by the database, so that they can be easily configured by logical operations and with bright outlook.

(Prerequisite 2)

The reward is determined by actual performance of merchandise sale in a period of time (Prerequisite 2). Based on the prerequisite, a reward amount obtained by a participant member during a specific period of time is determined by a “reward determination rule” shown as below, and a bonus percentage is calculated.

### First Embodiment Type: System

(Summary of Overall Structure and Operation of the System)

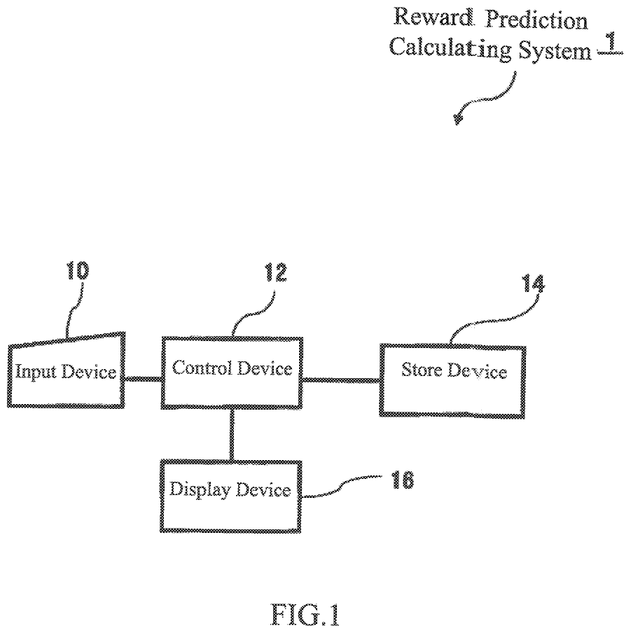

FIG. 1 is a diagram showing the entire structure of a reward prediction calculating system 1 according to an embodiment type of the present invention.

An input device 10 is a device that inputs the variable conditions and a calculation command, etc. that perform the reward prediction, to the device 1. The storage device 14 stores the “reward determination rule” and stores the inputted “variable conditions”.

The control device 12 stores the variable conditions in the storage device 14 once the variable conditions are inputted from the input device 10. Upon the calculation command is inputted, the control device 12 searches the reward determination rule 30 of the storage device 14, and accords the reward determination rule 30 to calculate the reward amount and sales amount corresponding to the variable conditions so as to calculate the bonus percentage and to display on the display device 16. During displaying, the control device 12 stores the displayed bonus percentage and the based variable conditions in the calculation result file 38 of the store device 14.

When a user finds out the displayed bonus percentage is not in expectation, the user can input the calculation command to the input device 10 again to update the variable conditions. However, if the user is satisfied with the result of the displayed bonus percentage after performing recalculation, the user can input a determination command in the input device, and the control device 12 then outputs the displayed bonus percentage and the based variable conditions to the calculation result file 38 of the store device 14.

(Hardware Structure)

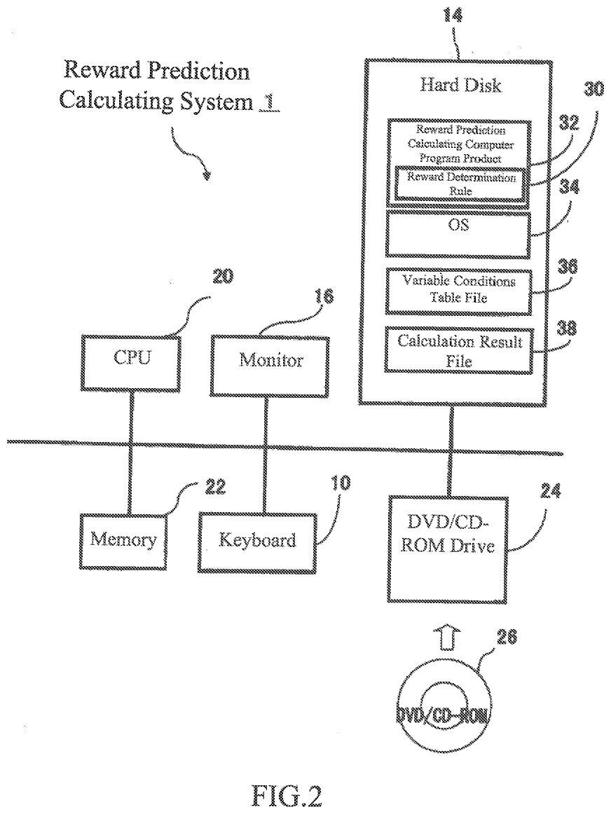

FIG. 2 shows a hardware configuration of a reward prediction calculating system 1 that the control device 12, as shown in FIG. 1, is implemented by using a central processing device (CPU) 20. In FIG. 2, the CPU 20 is connected to a memory 22, a monitor 16 as a display device, a keyboard 10 as an input device, a hard disk (HDD) 14 as a storage device, and a DVD/CD-ROM drive 24. The DVD/CD-ROM drive 24 is not limited to read a DVD/CD-ROM but can be a reader that reads other external storage media.

The hard disk 14 stores a reward determination rule 30, a reward prediction calculating computer program product 32, an OS (operating system) 34, the variable conditions table file 36 inputted from the keyboard 10, and a calculation result file 38 based on a final determinate result of the bonus percentage. The reward determination rule 30 and the reward prediction calculating computer program product 32 are installed in the storage device 14 from the DVD or the CD-ROM 26 via the DVD/CD-ROM drive 24. And other media can be stored in the storage device 14 by other interfaces.

The hard disk 14 is not limited to the above, and can be one device that can read or write out to other storage medium connecting to the CPU 20, such as an optical disk, an SSD, a USB memory.

In addition, although the reward determination rule 30 is set as a part of the reward prediction calculating computer program product 32, the present invention is not limited to this and may be another setting.

(Variable Conditions Table File)

The structure of the variable conditions table file 36 is shown in Table 1.

TABLE 1
Variable conditions Table

| No. | Item | Remark |
|---|---|---|
| 1 | The number of participant members | 2 persons (one person in |
| | branching from each participant | each left and right) |
| | member | |
| 2 | The purchasing merchandise item | 1 (unit) |
| | amount for each participant member | |
| 3 | The unilateral reward base value | a (unit) |
| 4 | The estimation period | Starting date~end date |
| 5 | The maximum reward amount | M (thousand Japanese yen) |
| 6 | The base reward amount | h (thousand Japanese yen) |
| 7 | The unit price of merchandise | A (thousand Japanese yen) |
| 8 | The entrance fee | b (thousand Japanese yen) |
| 9 | The depth of level | n (level) |

(A Reward Determination Rule)

The reward determination rule is for determining the reward by using the parameters shown in Table 1 to perform a calculation of the reward amount for all participant members on a basis of the allocation information of a total purchasing merchandise item amount that is the total amount of merchandise items purchased by other participant members in a lower level branching from the subject participant member, a predetermined maximum limitation amount, and a predetermined reward base value such that a temporary reward amount is obtained by performing an estimation which converges the bonus percentage to discretize the reward base value to all allocation levels in connection to the total purchasing merchandise item amount, and the reward amount is calculated according to the temporary reward amount which is not larger than the maximum reward amount.

(Parameters of a Reward Determination Rule)

The “reward determination rule” has a parameter (a variable) of a variation condition represented in Table 1. As described below, a function of F(i) (1≤i≤n) is taken as a function having these parameters to represent a bonus percentage of a participant member at the i-th level where the participant members are virtually located at levels with depth up to the n-th level.

The items (parameters) of the various condition table in Table 1 are explained as below. Except for the estimation period, the parameters are integers.

“The number of participant members branching from each participant member” (No. 1) has applied the binary tree data structure such that one person is respectively allocated in the left branch and the right branch, in total to be two persons.

“The purchasing merchandise item amount for each participant member” (No. 2) is set to one unit since one participant member purchases one merchandise item.

“The unilateral reward base value” (No. 3) is a parameter used to determine the number of reward units (u) by discretizing (in quantification) the total purchasing merchandise item amount of reward amount estimation for target participant members. The “unilateral” refers to one branch of the left and right branches that are branching from each participant member. Since the binary tree data structure is applied, twice the value of the unilateral reward base value is determined as the reward base value g for the calculation. Further, the “*” represents a multiplication sign (same in the following). In a calculation of the bonus percentage, the unilateral reward base value is the basic parameter with a great influence.

“The estimation period” (No. 4) is a period used to calculate the reward amount, and the purchasing merchandise item amount during the period is used as a basis to calculate reward amount.

“The maximum reward amount” (No. 5), which is set as M (Japanese yen), refers to a maximum reward amount obtained by a participant member in “the estimation period”. In addition, any other currency setting can be used in other cases instead of Japanese yen.

“The base reward amount” (No. 6), which is set as h (Japanese yen), is a reward amount paid to each of the above-mentioned reward unit u. A value obtained by multiplying the base reward amount by the reward unit becomes the temporary reward amount.

“The unit price of merchandise” (No. 7), which is set as A (Japanese yen), is a unit price of purchasing merchandise for a new participant member.

“The entrance fee” (No. 8), which is set as b (Japanese yen), is the amount that a new participant member pays to an incorporated company when joining in.

“The depth of the level” (No. 9) which is set as n (level), is the number of the levels counting from a root node (top) in the deployment of the binary tree data structure of the referral sale distribution membership group.

The reward determination rule is summarized as follows.

In the reward determination rule which is taken as a condition of reward paid to participant member, the total purchasing merchandise item amount S(i) is divided by the reward base value g (=2*a) so as take the quotient as the reward unit u (i), then each of the reward unit of the reward base amount is set as h (Japanese yen), and the temporary P (i) is a product that multiplies the base reward amount and the reward unit u (i). i.e., the total purchasing merchandise item amount S (i), is calculated as hierarchical value by discretizing (or in quantification) the reward base value g (=2*a) such that no reward is offered if the initial step is not to be reached, i.e., if the total purchasing merchandise item amount S (i) is lower than the reward base value g, the reward amount is zero. Since the total purchasing merchandise item amount S (i) is not directly proportional to the reward amount but has been discretized (quantified) to rounded out, the item amount above a threshold of any particular level will increase the reward amount and such evaluation will be performed in all levels.

In addition, although at each step it calculates based on what integer times the total purchasing merchandise item amount S (i) to the reward base value g and the reward base amount h is paid for each reward base value g, but the size of the step can be not calculated by using the integer times of the reward base value g, and can be varied in every step.

(A Reward of Participant Member in the i-Th Level)

Further details are detailed explained in accordance with the reward determination rule as below.

FIG. 7 shows the binary tree data structure which is a hierarchical structure with n levels. The structure is started from the 1st level, the below thereof is a 2nd level which are two nodes branching left and right from the 1^{st} level, the below thereof is the 3rd level which are two nodes branching left and right from the 2nd level, . . . in the same manner the i-th level which are two nodes branching left and right from the (i−1)-th level, . . . , and the n-th level which are two nodes branching left and right from the (n−1)-th level.

According to table 1 which shows the variable conditions table, since the purchasing merchandise item amount for each participant member is one unit, if the purchasing merchandise item amount for the lower (i.e., lower level) participant member group of the subject participant member in the i-th level (excluding the one unit purchased by the subject participant member in the i-th level himself) is configured as S(i), S(i) is consistent with the number of participant members who are allocated in the lower level branching from the node of the subject participant member, and can be obtained from the total number of participant members of the binary tree data structure starting from the i-th level and ending at the n-th level (2ⁿ⁻⁽ⁱ⁻¹⁾−1) and minus 1 therefrom as represented in Formula 1 shown below. Further, the total number of participant members in the binary tree data structure from the 1st level to the n-th level is 2⁰+2¹+2²+ . . . +2⁽ⁿ⁻¹⁾=2ⁿ−1

S(i)=2ⁿ⁻⁽ⁱ⁻¹⁾−1)−1 (unit)

=2ⁿ⁺¹⁻ⁱ−2 (unit) [Formula 1]

With respect to calculation of reward amount, the reward amount can be determined by determining the reward base amount in advance to obtain the product of total purchasing merchandise item amount and the reward base amount such that the reward amount is determined by applying a (linear) proportion relation to the total purchasing merchandise item amount.

However, if a specific number is taken as a threshold value and a reward will be paid once the threshold is exceeded, it can expect an increase in motivation of participant member introduction to reach the value of the threshold. Further, if the threshold value is variable, the motivation and the reward of participant member introduction can be determined more precisely. Therefore, “the total purchasing merchandise item amount” is discretized by using the reward base value g to convert into the reward unit u (i) so as to obtain the estimation.

As a result, the reward unit u(i) (as shown in Formula 2) can be represented as an integer portion of a value obtained from a result that S(i)=2ⁿ⁺¹⁻ⁱ−2 (number) (as shown in Formula 1) is divided by the reward base value g. Herein, if the reward base value g is set to be twice of the unilateral reward base value a (2*a), the reward unit u(i) is an integer portion of quotient of operation that S(i) is divided by 2*a.

$$\begin{matrix}u ( i ) = INT \{ S ( i ) / g \} \\ = INT \{ S ( i ) / ( 2 * a ) \} ( unit )\end{matrix} \qquad [ Formula 2 ]$$

Herein, INT{ } is an operator that grabs an integer portion of value in the parentheses (the following is the same). The reward base amount is determined in advance such that it is multiplied by the reward unit u (i) so as to determine the reward amount.

In this way, a reward amount P (i) obtained by a participant member in the i-th level during a estimation period (as shown in Formula 3) is the product of the reward base amount h (Japanese yen) and the reward unit u (i) (as shown in Formula 2).

P(i)=h*u(i) (Japanese yen) [Formula 3]

(Importation of a Maximum Reward Amount)

The reward amount P(i) of the participant member in the i-th level is determined by the Formula 3 as shown above, but the deeper the n of the level is the closer exponential relationship it will be such that an divergence of bonus percentages is concerned. However, since the payment amount P(i) is set as the temporary reward amount, and the maximum reward amount M (Japanese yen) is set as the ceiling amount such that the bonus percentages will not diverge.

Since the maximum reward amount M is a limitation of reward, it is expected to be fair and acceptable by the participant members. Therefore, the temporary reward amount P (i) is calculated first, and then the maximum reward amount is set to limit the reward amount exceeding the maximum reward amount.

The level whose temporary reward amount P (i) has reached the maximum reward amount M (the level whose initial reward amount exceeds the maximum reward amount) is taken as the m-th level as counting from the n-th level, where m can be the smallest value of k that satisfies the following inequality (shown in Formula 4).

However, since i is counted from the 1st level and k is counted from the n-th level, i and k have a relationship of i+k=n+1. In consideration together with Formula 1, the m which is the smallest value of k is determined by three parameters including M, h, a (or g), but is not determined by n. That is, m is a constant without relation to n (shown in Formula 4).

$$\begin{matrix}M \leq Pi = h * u ( i ) \\ = h * INT \{ S ( i ) / g \} \\ = h * INT \{ ( {2}^{n + 1 - i} - 2 ) / g \} \\ = h * INT \{ ( {2}^{k} - 2 ) / g \}\end{matrix} \qquad [ Formula 4 ]$$

Thereafter, m which is a level reaching the maximum reward amount M is obtained, and thereafter a reward amount of participant member in a level branching therefrom is obtained. By means of the above, the reward amount for the participant member from the 1st level to the (n+1−m)-th level is limited to the maximum reward amount M Japanese yen.

[Condition 1]:

For a participant member belonging to a level i where i≤n+1−m, the reward amount thereof is set to the maximum reward amount M Japanese yen.

[Condition 2]:

For a participant member belonging to a level i where i>n+1−m, the reward amount thereof is set to the temporary reward amount P(i) where P(i)=h*INT{(2ⁿ⁺¹⁻ⁱ−2)/g}

If the reward base value g is applied to be twice the unilateral reward base value a, it has been agreed to have the purchasing merchandise item amount of the participant members belonging to the left and right branches of the node of the subject participant member in the binary tree data structure to be allocated, in way of balance in a value of “a”, in each one of two lower level participant members. In addition, it is easy to be intuitively accepted the hierarchical estimation obtained by discretization.

According to the above varying conditions, the total reward amount B of the entire group in the estimation period is calculated according to the Condition 1 and the Condition 2, respectively. In Condition 1, the reward amount of a participant member is always limited to the maximum reward amount M, where it is nothing to do with the level to which a participant member belongs. In Condition 2, the reward amount of a participant member belonging to the i-th level is with the same amount as the temporary reward amount P(i), and the reward amount is varied according to which level that participant member is.

(Total Reward Amount BM in Condition 1)

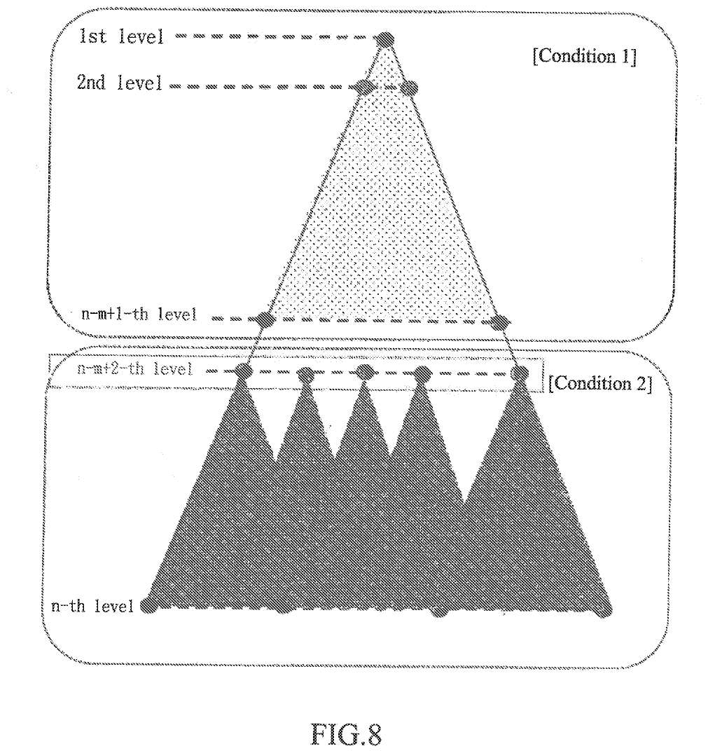

In the Condition 1, as shown in FIG. 8, the participant member's reward amount from the (n+1−m)-th level to the top is always the maximum reward amount of M Japanese yen. Therefore, as shown in the next formula, Formula 5, the total amount BM of the Condition 1 may be calculated by an operation that multiplies the maximum reward amount of M Japanese yen by the sum of the number of participant members from the 1st level to the (n+1−m)-th level.

$$\begin{matrix}BM = M * {\sum }_{i = 1}^{n - m + 1} {2}^{i - 1} \\ = M * ( {2}^{n - m + 1} - 1 )\end{matrix} \qquad [ Formula 5 ]$$

(Total Reward Amount BR in Condition 2)

In Condition 2, the reward amount P(i) for one participant member in each level does not reach the maximum reward amount. As shown in FIG. 8, the topmost participant member of the binary tree data structure of Condition 2 belongs to the (n−m+2)-th level. As a result, the total reward amount BP (Japanese yen) of all participant members belonging to the group and its lower group (down line) is calculated by the summation of the reward amount for all the participant members from the (n−m+2)-th to the n-th level (The portions of each hidden lines in FIG. 8). Therefore, considering the same as in the Formula 5, based on the first line of the following Formula 6, the second line of the Formula 6 is obtained by introducing Formula 2 and 3 thereto. By rewriting n−m+2=1, the Formula 6 can be rewritten as shown in third line since n=m−1, n−i+1=m−1, and i−1=i−(n−m+2).

$$\begin{matrix}BP = {\sum }_{i = n - m + 2}^{n} P ( i ) * {2}^{i - ( n - m + 2 )} \\ = {\sum }_{i = n - m + z}^{n} h * INT ( \frac{{2}^{n - i + 1} - 2}{2 * a} ) * {2}^{i - ( n - m + 2 )} \\ = h * {\sum }_{i = 1}^{m - 1} INT \{ \frac{{2}^{m - i} - 2}{2 * a} \} * {2}^{i - 1}\end{matrix} \qquad [ Formula 6 ]$$

As shown in FIG. 8, the BP calculated by Formula 6 is total reward amount of a participant member in the (n−m+2)-th level and the lower level participant members branching therefrom. The total reward amount BR (in Condition 2) is calculated as (shown as Formula 7) the product of BP and the total reward amount of the total number of participant members 2^{m-m+1} belonging to the (n−m+2) level. Although each hatching portion of the Condition 2 is overlapped with each other as shown in FIG. 8, it does not indicate that the overlapped portions having the common data.

BR=BP*2^{n-m+1} [Formula 7]

As a result, the total reward amount B of the participant members in the estimation period is the sum of the reward amount BM (Condition 1) shown in Formula 5 and the total reward amount BR (Condition 2) shown in Formula 7. Therefore, the total reward amount B of the participant members in the estimation period is represented by the following Formula 8.

$$\begin{matrix}B = BM + BR \\ = M * ( {2}^{n - m + 1} ) + BP * {2}^{n - m + 1} \\ = ( M + BP ) * {2}^{n - m + 1} - M\end{matrix} \qquad [ Formula 8 ]$$

The total amount I received by the incorporated company in the estimation period combining the unit price of merchandise A and the entrance fee (registration fee) b can be represented by the following Formula 9.

I=A*(2ⁿ−1)+b*2ⁿ⁻¹=(2*A+b)*2ⁿ⁻¹−A [Formula 9]

Since the bonus percentage F(n) is obtained by operation that divides Formula 8 by Formula 9, the bonus percentage F(n) can be expressed by the following Formula 10.

$$\begin{matrix}F ( n ) = B / I \\ = \{ ( M + BP ) * {2}^{n - m + 1} - M \} / \\ \{ ( 2 * A + b ) * {2}^{n - 1} - A \} * 100 ( \% )\end{matrix} \qquad [ Formula 10 ]$$

(The Convergence of the Bonus Percentage F(n))

The calculated bonus percentage F(n) must show convergence. The limit value of the Formula 10 as n is set to infinity is expressed by the following Formula 11.

lim F(n)=(M+BP)/{2^{m-2}*(2*A+b)}*100(%) (n→∞) [Formula 11]

It represents that the right side of Formula 11 converges to a fixed value that does not relate to n when n becomes infinite. Therefore, since the bonus amount is determined by the reward determination rule shown in (Condition 1) and (Condition 2), the bonus amount will never diverge (shown as Formula 11). Since bonus percentage is determined according to the bonus amount, therefore it will not go wrong in theory. Therefore, since the calculated bonus percentage F(n) becomes a definite value, it can be understood that this is a highly reliable and extremely powerful bonus index. Since the above bonus amount determination has not yet appeared, the reward prediction based on this reward determination rule is extremely powerful.

(The Calculation Processing)

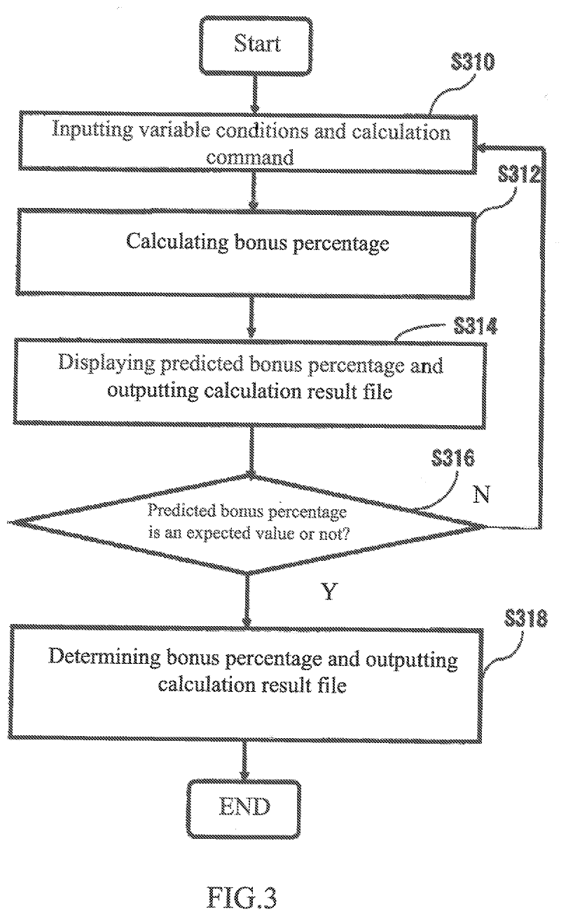

FIG. 3 shows a reward prediction calculating computer program product 30 in a flowchart. The processing procedure will be described below with reference to this flow chart.

(S310) The variable conditions are inputted from the keyboard 10 and stored in the hard disk (HDD) 14. Similarly, a calculation command is inputted to start the calculation of the bonus percentage.

(S312) The variable conditions are read from the HDD 14 to predict the reward amount and the total sales amount in accordance with the reward determination rule described later. Next, the predicted bonus percentage is calculated by dividing the predicted reward amount by the predicted total sales amount.

(S314) The predicted bonus percentage is displayed on the monitor 16 and is recorded with the corresponding variable conditions in the calculation result file 38 of the HDD 14.

(S316) If the predicted bonus percentage is an expected value, the process proceeds to (S318). If not, the process returns to step S310 and estimated bonus percentage is calculated again in accordance with the variable conditions and the calculation command.

(S318) The expected bonus percentage and the variable conditions thereof are outputted to the HDD 14 and recorded.

### Second Embodiment Type

In the first embodiment type, a database recording the reward determination rule or computer program is stored in a device that performs processing. The present invention is not limited to this, and it is more convenient that the database is stored in other devices and is accessed via a communication line.

In the second embodiment type, the reward determination rule is taken as an arithmetic program to be installed in the server. In this case, since the terminal device transmits the variable conditions to the server and the server transmits the operation result to the terminal unit, the variable conditions can be simply modified from the terminal unit to obtain the bonus percentage.

The embodiment type can handle the amount difference between the bonus obtained in this embodiment type and the practical performance in way of quantification so that it can easier cope with the situation and provide/manage a more reasonable reward plan.

(Processing Server)

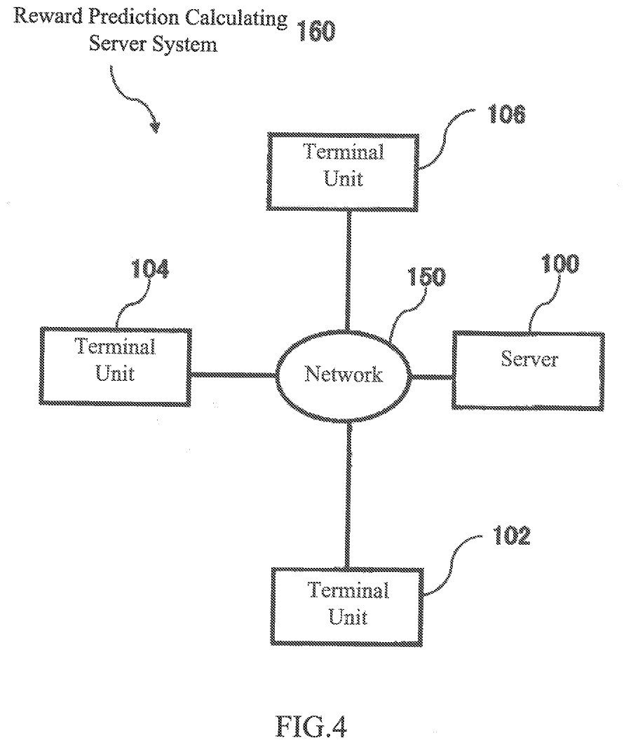

A reward prediction calculating server system 160 according to the present embodiment type is shown in FIG. 4. In this embodiment type, the reward prediction calculating server (processing server) 100 and the terminal unit 102, 104, 106 . . . are connected via a network. The server 100 records the reward prediction calculating computer program product and the reward determination rule, and operates as a network server (cloud server). The terminal unit 102, 104, 106 . . . and the like can access the server 100 and utilize the reward prediction calculating function.

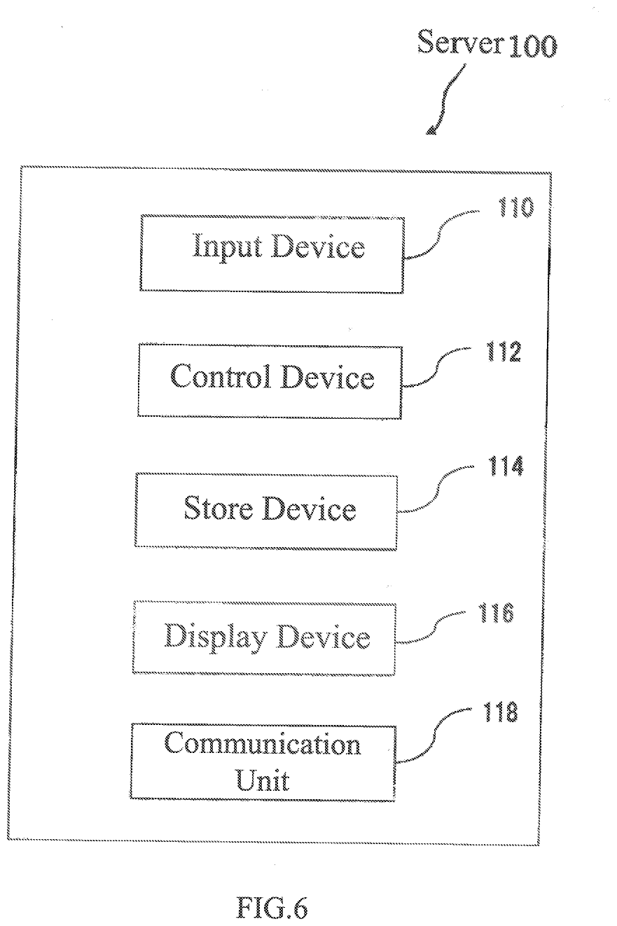

FIG. 6 is a diagram showing the entire structure of the reward prediction calculating server 100 according to the second embodiment type of the present invention, including an input unit 110, a control unit 112, a storage unit 114, a display unit 116, and a communication unit 118.

The input unit 110 is an interface that provides necessary information from a user to the server. It is not only an interface to a human, such as a keyboard mouse and a voice input device, but also an interface for other programs and other computers, such as an interface circuit, an interface program and the like.

The control unit 112 performs control operation for the calculation of the bonus percentage by obtains information together with at least the terminal devices 102, 104, 106 . . . , and the storage unit 114.

The storage unit 114 is a unit that stores at least the reward prediction calculating computer program product and stores the calculation of the bonus percentage and the result thereof, and stores the user registration information and the like if necessary.

The display unit 116 is a device for displaying at least bonus percentage. For example, it can be used as a display device.

The communication unit 118 uses the communication network or the like to communicate with the outside of the server 100.

Although the hardware configuration of the terminal devices 102, 104, 106 . . . is not shown, basically it is the same as the hardware configuration of the server 100 shown in FIG. 6. Furthermore, since the terminal device is a client, it needs neither to store the reward prediction calculating computer program product and the like nor to calculate the reward prediction as long as the variable conditions a able to be transmitted to the server 100 and the result of the reward prediction is able to be received.

(The Variable Conditions)

The variable conditions are the same as those shown in Table 1 of the first embodiment type.

(The Processing Flow)

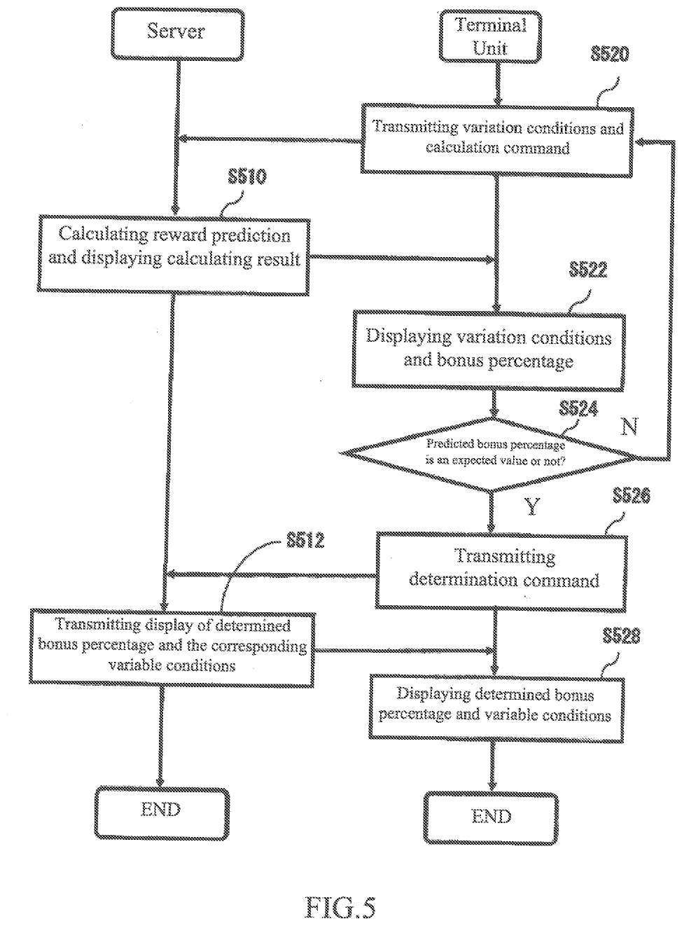

FIG. 5 shows a flow chart of a reward prediction calculating computer program product recorded in the server 100 and a flow chart of a browsing program recorded in the corresponding terminal device 102.

Initially, the server 100 receives the access from the terminal unit 102, 104, 106 . . . via the communication unit 118 and receives the user identifier inputted to the terminal unit to allow the server 100 to be logged in (Not shown). At this time point, the allowance can be given if the control unit 112 has verified the user identifier information which is in advance stored in the storage unit 114. For example, “0102” is taken as the user identifier and is transmitted, and at this time point a password may be used for sake of security.

(S520) Next, the terminal unit 102, whose login has been allowed, transmits the variable conditions and the calculation command to the server 100.

(S510) The server 100 receives this and records the variable conditions in the storage unit 114. At this time point, the reward determination rule stored in the storage unit 114 and the reward prediction calculating computer program product are started to initiate the control unit 112 to calculate the reward prediction and bonus percentage. While calculating results including the bonus percentage, the variable conditions and the like are recorded in the storage unit 114, the results are transmitted to the terminal unit 102 through the communication unit 118.

(S522) As the terminal unit 102 receives this, the browsing program will show the display of the calculated result on the screen.

(S524) If the user considers the bonus percentage is desired, the program proceeds to step S526 and transmits a determination command to the server 100 by the user's operation. If not, the system jumps to (S520) and other variation conditions and the calculation commands are transmitted to the server 100 for the calculation again. These processes are repeated, and the server 100 performs the calculation again to transmit the result to the terminal unit 102.

(S512) While receiving a determination command transmitted in step S526, the server 100 transmits a display of determined bonus percentage and the corresponding variable conditions to the terminal unit 102.

(S528) While transmitting the display of step 512, the terminal unit 102 displays the received determined bonus percentage and the variable conditions.

By means of performing the above, the terminal unit 102 and the like can use the reward prediction calculating computer program product of the server 100.

### Embodiment 1

Hereinafter, an example that calculates the obtained bonus percentage is shown in accordance with the reward determination rule of the present invention. This method is applicable to either a device or a server.

### Calculation Example 1

The bonus percentage F is calculated in accordance with the reward determination rule to extract variable conations from the basic condition of the reward plan. The variable conditions are determined as shown in Table 2.

As shown in Table 2, the reward base value g (unilateral reward base value a), the maximum reward amount M, and the base reward amount h, which are extracted as main parameters.

g, a: the unilateral reward base value a is 3 units (the reward base value g then is 6 units)

M: The maximum reward amount M is 2,400,000 Japanese yen

h: The base reward amount h is 5,000 Japanese yen

TABLE 2
Variable conditions Table of Embodiment Type 1

| No. | Item | Remark |
|---|---|---|
| 1 | The number of participant members | 2 persons (one person in |
| | branching from each participant | each left and right) |
| | member | |
| 2 | The purchasing merchandise item | 1 (unit) |
| | amount for each participant member | |
| 3 | The unilateral reward base value | a = 3 (unit) |
| 4 | The estimation period | Starting date~end date |
| 5 | The maximum reward amount | M = 2400 |
| | | (thousand Japanese yen) |
| 6 | The base reward amount | h = 5 |
| | | (thousand Japanese yen) |
| 7 | The unit price of merchandise | A = 10 |
| | | (thousand Japanese yen) |
| 8 | The entrance fee | b = 3 |
| | | (thousand Japanese yen) |
| 9 | The depth of level | n = 15 (level) |

In the condition of M, h, and a, while the depth of the level n=15 (in a situation that the number of participant members is 32,000 or more), in order to obtain, by using Formula 4, a value of level m which has reached the maximum limitation amount m, it is found that a value of m, which is a minimum value of k filled in Formula 4, is:

m=12.

As a result, when m and n is taken as a condition, the total reward amount BM of (Condition 1) can be obtained by Formula 5:

$$\begin{matrix}BM = M * ( {2}^{5} - 1 ) \\ = \text{2,400,000} * 15 = \text{36,000,000} ( Japanese yen )\end{matrix}$$

On the other hand, according to Formula 6, BP of (Condition 2) becomes:

$$\begin{matrix}BP = h * \text{2,845} \\ = 5000 * \text{2,845} = \text{14,225,000} ( Japanese yen )\end{matrix}$$

The total reward amount BR (in Condition 2)) is expressed by Formula 7:

$$\begin{matrix}BR = BP * 24 \\ = \text{14,225,000} * 16 = \text{227,600,000} ( Japanese yen ) .\end{matrix}$$

Therefore, according to Formula 8:

$$\begin{matrix}The total reward amount B = BM + BR becomes \\ = \text{36,000,000} + \text{227,600,000} \\ = \text{263,600,00} ( Japanese yen )\end{matrix}$$

On the other hand, the total amount I received by the incorporated company is represented by Formula 9:

$$\begin{matrix}\text{The incorporated company I} = A * ( {2}^{n} - 1 ) + b * {2}^{n - 1} = ( 2 * A + b ) * \\ {2}^{n - 1} - A \\ = ( 2 * \text{10,000} + \text{3,000} ) * {2}^{14} - \text{10,000} \\ = \text{376,822,000} ( Japanese yen ) .\end{matrix}$$

$$\begin{matrix}\text{The bonus percentage} F ( 15 ) = ( B / I ) * 100 ( \% ) \\ = ( \text{263,600,000} / \text{376,822,000} ) * 100 ( \% ) \\ = 69.95 \% .\end{matrix}$$

This bonus can be called a solid bonus that can curb risk.

The general bonus percentage F(n), in general, may not be in consistency with the one in practical performance. The reason can be predicted as the deviation of each participant member's introducer and the deviation of introducer in local area. The incorporated company is able to obtain important information to reflect in the setting method of the reward plan by further analyzing this inconsistency. By means of the above, since the amount estimation of the bonus percentage F(n) can be performed in way of quantification in connection to the reward plan, a new reward plan that is more attractive and less risky can be devised.

### Embodiment 2

### Calculation Example 2: The Case where “a” is Set to “2”

Next, a calculation example that the unilateral reward base value a is set to 2 is shown with a change of the variable conditions.

As shown in Table 3, the reward base value g (unilateral reward base value a), the maximum reward amount M, and the base reward amount h, which are extracted as main parameters.

g, a: unilateral reward base value a is 2 units (the reward base value g becomes 4 units)

M: The maximum reward amount M is 2,400,000 Japanese yen

h: The base reward amount h is 5,000 Japanese yen

TABLE 3
Variable conditions Table of Embodiment Type 2

| No. | Item | Remark |
|---|---|---|
| 1 | The number of participant members | 2 persons (one person in |
| | branching from each participant | each left and right) |
| | member | |
| 2 | The purchasing merchandise item | 1 (unit) |
| | amount for each participant member | |
| 3 | The unilateral reward base value | a = 2 (unit) |
| 4 | The estimation period | Starting date~end date |
| 5 | The maximum reward Amount | M = 2400 |
| | | (thousand Japanese yen) |
| 6 | The base reward amount | h = 5 |
| | | (thousand Japanese yen) |
| 7 | The unit price of merchandise | A = 10 |
| | | (thousand Japanese yen) |
| 8 | The entrance fee | b = 3 |
| | | (thousand Japanese yen) |
| 9 | The depth of level | n = 15 (level) |

The case with a=2 (with two left branch and two right branches) is the same as that in the calculation example 1.

In a condition that the depth of the level is n==15, the following result is obtained by applying the Formula 10 to calculate the bonus percentage. In this case, the same calculation as in the calculation example 1 is performed,

m=11,

the bonus percentage F(15)=95.9%.

Such bonus percentage in the bonus estimation is rather high, and the incorporated company may have relative high risk. However, if the history tendency and the real situation is considered to lower the bonus percentage (for example, the bonus percentage of real performance can be estimated with 50% degree), the investigation of the reward plan can be that the reward plan is with strongly attractive appeal in spite that a risk is existed.

### Embodiment 3

### Calculation Example 3: The Case where a is Set to =4

In addition, a calculation example where “a” is set to “4” is shown with a change of the variable conditions. This is a case that a participant member buys more merchandise

As shown in Table 4, the reward base value g (unilateral reward base value a), the maximum reward amount M, and the base reward amount h, which are extracted as main parameters.

g, a: unilateral reward base value a is 4 units (reward base value g becomes 8 units)

M: the maximum reward amount M is 2,400,000 Japanese yen

h: the base reward amount h is 5,000 Japanese yen

TABLE 4
Variable conditions Table of Embodiment Type 3

| No. | Item | Remark |
|---|---|---|
| 1 | The number of participant members | 2 persons (one person in |
| | branching from each participant | each left and right) |
| | member | |
| 2 | The purchasing merchandise item | 1 (unit) |
| | amount for each participant member | |
| 3 | The unilateral reward base value | a = 4 (unit) |
| 4 | The estimation period | Starting date~end date |
| 5 | The maximum reward Amount | M = 2400 |
| | | (thousand Japanese yen) |
| 6 | The base reward amount | h = 5 |
| | | (thousand Japanese yen) |
| 7 | The unit price of merchandise | A = 10 |
| | | (thousand Japanese yen) |
| 8 | The entrance fee | b = 3 |
| | | (thousand Japanese yen) |
| 9 | The depth of level | n = 15 (level) |

The case with a=4 (four left branches and four right branches) is the same as those in the calculation examples 1 and 2. In this case, the same calculation as in the calculation examples 1 and 2 is performed:

m=12,

the bonus percentage F(15)=47.6%.

In this case, the bonus percentage is less than 50%. It is less risky than the example 2, and will be estimated as an unattractive reward plan.

As described above, the bonus percentage is calculated using Formula 10 in Calculation Examples 1 to 3. By changing the three parameters (variation conditions) of h, M, and g to determine the reward plan, it is easy to obtain a certain convergence bonus percentage. In addition, by changing the unit price A and the entrance fee b to set different bonus percentages, a flexible and easy estimation and prediction of the reward plan can be performed.

The advantages of this prediction are the following.

First, since the prediction is performed before the start of the referral business organization, it is possible to flexibly determine the reward plan with quantitative and reliable indicators while taking account of various economic conditions and the like.

Second, since the prediction is performed after the start of the referral business organization, it is possible not only to predict the bonus percentage of all incorporated companies, but also to identify a spot organization which is a operated lively so as to build the expanding strategy for the whole organization by evaluating the difference between the actual value and predicted value for each participant member.

As a result, it is not only the reward prediction calculating can be converged, and since the parameters which can be easily and intuitive complained including the unit price A and the entrance fee b are operated to calculate the reward prediction, an attractive plan can be easily built up for the participant members. In addition, for the incorporated company, it becomes easy to investigate a real plan which considers the survival/steadiness of the management and cooling down of the overheating introduction. Therefore, it provides a practical and versatile reward prediction calculating technology in response to the needs of the society.

### EXPLANATION OF LETTERS AND NUMBERS

1 Reward Prediction Calculating System
10 Input Device
12 Control Device
14 Store Device
16 Display Device->Monitor
20 CPU
22 Memory
24 DVD/CD-ROM Drive
26 DVD/CD-ROM
30 Reward Determination Rule
32 Reward Prediction Calculating Computer Program Product
34 Reward Determination Rule
36 Variable Conditions Table File
38 Calculation Result File
100 Server
102,104,106 Terminal Unit
110 Input Device
112 Control Device
114 Store Device
116 Display Device
118 Communication Unit
132 Reward Prediction Calculating Computer Program
134 Browsing Program
150 Network
A Unit Price of Merchandise
a Unilateral Reward Base Value
B Total Reward Amount
BM Sum of the Reward Amount (Condition 1)
BR Sum of the Reward Amount (Condition 2)
BP Total Reward Amount of a Participant Member in the Level and the
Lower Level Participant Members Branching therefrom
b Entrance Fee
F(n) Obtained Bonus Percentage
g Reward Base Value
h Base Reward Amount
I Total Amount
M Maximum Reward Amount
P (i) Reward Amount of the participant member in the i-th level
S (i) Purchasing Merchandise Item Amount for the Lower Participant Member Group of the Subject Participant Member in the i-th level
u (i) Reward Unit

What is claimed is:

1. A reward prediction calculating system (1) that predicts, according to a reward amount of a participant member, bonus percentages of the participant member who participates in a referral sale distribution membership group, the reward prediction calculating system (1) comprising:
an input device that inputs the variable conditions, a calculation command, and then a determination command, the variable conditions being used to calculate the reward amount;
a storage device that records the inputted variable conditions and a reward determination rule, the reward determination rule being with converged bonus percentages;
a control device that repeatedly, during a period that is after the input of the calculation command and is before the input of the determination command, calculates the reward amount to perform the prediction of the bonus percentages according to the variable conditions and the reward determination rule;
a display device that displays the obtained prediction of the bonus percentages; and
an output device that outputs, after the determination command is inputted, the bonus percentages and the variable conditions as determination data, the bonus percentages being related to the determination command, and the variable conditions being synchronously stored while being displayed,
wherein the reward determination rule comprises:
[1] allocation information, with the participant members being mapped after the participant members are respectively virtually allocated to one node in a binary tree data structure to form filled levels; and
[2] a calculation of the reward amount for all participant members,
which is performed based on the allocation information and on a basis of a total purchasing merchandise item amount(S(i)) that is the total amount of merchandise items that are purchased by other participant members in a lower level branching from the subject participant member, a predetermined maximum limitation amount (M), and a predetermined reward base value(g)
such that a temporary reward amount (P(i)) is obtained by performing an estimation which discretizes the reward base value(g) to all allocation levels in connection to the total purchasing merchandise item amount(S(i)), and the reward amount is calculated on a basis that the temporary reward amount is not larger than the maximum reward amount.

2. The reward prediction calculating system (1) as claimed in claim 1, wherein the temporary reward amount is P(i) in relation to the reward amount of the participant member who belongs to the ith level of a n level depth binary tree is determined as
P(i)=h*INT{S(i)/g},
where the maximum reward amount (M) is M, the base reward amount (h) is h, the reward base (g) is g, the amount of merchandise item that is purchased by each participant member is 1, the total purchasing merchandise item amount is S(i), and the temporary reward amount is P(i), INT{ } is an operator to obtain an integer value from the value in { }, and * is an accumulation operator,
the determined reward amount P(i) satisfies a relation of:
M≤P(i) and k+i=n+1,
wherein it divides to two different conditions to calculate the reward amount by means of a level number i which has a number m obtained by a counting from the level n and has a number k being the smallest value of m,
[condition 1]:
the reward amount of the participant member in a level i, where i≤n+1−m, is calculated as the maximum reward amount M,
[condition 2]:
the temporary reward amount of the participant member in a level of i, where i>n+1−m, is calculated as the temporary reward amount P(i)=h*INT {(2n−i+1−2)/g}.

3. A reward prediction calculating server (100) that predicts, according to a reward amount of a participant member, bonus percentages of the participant member who participates in a referral sale distribution membership group, the reward prediction calculating server (100) comprising:
a communication component (116) that is configured to be communicable with a terminal unit (102, 104, 106) via a network (110), to receive data related to a calculation of the reward amount from the terminal unit, and to send bonus percentages to the terminal unit, the received data including the variable conditions, a calculation command, and a determination command, and the bonus percentages obtained by a calculation and including an estimated bonus percentage and the bonus percentages which are taken as determination data while the determination command is received;
a storage component (114) that records the received variable conditions and a reward determination rule, the reward determination rule being with converged bonus percentages;
a control component (112) that repeatedly, during a period that is after the input of the calculation command and is before the input of the determination command, calculates the reward amount to perform the prediction of the bonus percentages according to the variable conditions and the reward determination rule;
a data providing component that provides, after the receipt of the inputted determination command, the predicted bonus percentage and an amount estimation in connection to the bonus percentages to the terminal unit,
wherein the reward determination rule comprises:
[1] allocation information, with the participant members being mapped after the participant members are respectively virtually allocated to one node in a binary tree data structure to form filled levels; and
[2] a calculation of the reward amount for all participant members, which is performed based on the allocation information and on a basis of a total purchasing merchandise item amount(S(i)) that is the total amount of merchandise items that are purchased by other participant members in a lower level branching from the subject participant member, a predetermined maximum limitation amount (M), and a predetermined reward base value(g) such that a temporary reward amount(P(i)) is obtained by performing an estimation which discretizes the reward base value(g) to all allocation levels in connection to the total purchasing merchandise item amount(S(i)), and the reward amount is calculated on a basis that the temporary reward amount is not larger than the maximum reward amount.

4. A reward prediction calculating computer program product that predicts, according to a reward amount of a participant member, bonus percentages of the participant member who participates in a referral sale distribution membership group, the reward prediction calculating computer program product being provided to enable a computer to function as:
an input element that inputs the variable conditions, a calculation command, and then a determination command, the variable conditions being used to calculate the reward amount;
a storage element that records the inputted variable conditions and a reward determination rule, the reward determination rule being with converged bonus percentages;
a control element that repeatedly, during a period that is after the input of the calculation command and is before the input of the determination command, calculates the reward amount to perform the prediction of the bonus percentages according to the variable conditions and the reward determination rule;
a display element that displays the obtained prediction of the bonus percentages; and
an output element that outputs, after the determination command is inputted, the bonus percentages and the variable conditions as determination data, the bonus percentages the variable conditions being synchronously stored while being displayed,
wherein the reward determination rule comprises:
[1] allocation information, with the participant members being mapped after the participant members are respectively virtually allocated to one node in a binary tree data structure to form filled levels; and
[2] a calculation of the reward amount for all participant members, which is performed based on the allocation information and on a basis of a total purchasing merchandise item amount(S(i)) that is the total amount of merchandise items that are purchased by other participant members in a lower level branching from the subject participant member, a predetermined maximum limitation amount (M), and a predetermined reward base value(g) such that a temporary reward amount(P(i)) is obtained by performing an estimation which discretizes the reward base value(g) to all allocation levels in connection to the total purchasing merchandise item amount(S(i)), and the reward amount is calculated on a basis that the temporary reward amount is not larger than the maximum reward amount.

5. A reward prediction calculating method that predicts, according to a reward amount of a participant member, bonus percentages of the participant member who participates in a referral sale distribution membership group, the reward prediction calculating method comprising:
an input step that inputs the variable conditions for a calculation of the reward amount;
a storage step that records the inputted variable conditions;
a control step that repeatedly, during a period that is after the input of the calculation command and is before the input of the determination command, calculates the reward amount to perform the prediction of the bonus percentages according to the variable conditions and the reward determination rule;
a display step that displays the obtained prediction of the bonus percentages; and
an output step that outputs, after the determination command is inputted, the bonus percentages and the variable conditions as determination data, the bonus percentages and the variable conditions being synchronously stored while being displayed,
wherein the reward determination rule comprises:
[1] allocation information, with the participant members being mapped after the participant members are respectively virtually allocated to one node in a binary tree data structure to form filled levels; and
[2] a calculation of the reward amount for all participant members, which is performed based on the allocation information and on a basis of a total purchasing merchandise item amount(S(i)) that is the total amount of merchandise items that are purchased by other participant members in a lower level branching from the subject participant member, a predetermined maximum limitation amount (M), and a predetermined reward base value(g) such that a temporary reward amount(P(i)) is obtained by performing an estimation which discretizes the reward base value(g) to all allocation levels in connection to the total purchasing merchandise item amount(S(i)), and the reward amount is calculated on a basis that the temporary reward amount is not larger than the maximum reward amount.
